(19) United States
(12) Patent Application Publication
(10) Pub. No.: US 2016/0101607 A1
(43) Pub. Date: Apr. 14, 2016

(54) ELASTOMER PMMA LAYERED COMPOSITES HAVING IMPROVED PROPERTIES

(71) Applicants: Werner HOESS, Messel (DE); Arne SCHMIDT, Darmstadt (DE); Antonios MANIS, Darmstadt (DE)

(72) Inventors: Werner HOESS, Messel (DE); Arne SCHMIDT, Darmstadt (DE); Antonios MANIS, Darmstadt (DE)

(73) Assignees: EVONIK ROEHM GMBH, Darmstadt (DE); BASF SE, Ludwigshafen (DE)

(21) Appl. No.: 14/787,996

(22) PCT Filed: Apr. 17, 2014
(86) PCT No.: PCT/EP2014/057858

§ 371 Date: Oct. 29, 2015

(30) Foreign Application Priority Data
Apr. 29, 2013 (DE) 10 2013 207 813.7
Mar. 7, 2014 (DE) 10 2014 204 189.9

(51) Int. Cl. B32B 27/40; B32B 37/10; B32B 27/30; B32B 37/06; B32B 27/08; B32B 27/18

(52) U.S. Cl. CPC B32B 27/40; B32B 27/08; B32B 27/18; B32B 27/308; B32B 37/06; B32B 37/10; B32B 2307/102; B32B 2605/006; B32B 2307/412; B32B 2419/00; B32B 2250/03; B32B 2309/12; B32B 2309/02

(57) ABSTRACT

The invention relates to a plastics laminate in particular for vehicle glazing. The composite is composed of at least three layers, where the two exterior layers are composed of a transparent polymethyl (meth)acrylate (PMMA) and the internal layer is composed of a thermoplastic polyurethane (TPU). The plastics laminate passes the ECE R43 falling-ball test and has better acoustic properties than prior-art plastics composites of the same size.

### FIELD OF THE INVENTION

The invention relates to a plastics laminate in particular for vehicle glazing. The composite is composed of at least three layers, where the two exterior layers are composed of a transparent polymethyl (meth)acrylate (PMMA) and the internal layer is composed of a thermoplastic polyurethane (TPU). The plastics laminate passes the ECE R43 falling-ball test and has better acoustic properties than prior-art plastics composites of the same size.

### PRIOR ART

Applications in technical fields such as partitions, architectural glazing or automotive glazing require transparent sheets or panels with high fracture resistance. Transparent plastics such as PMMA provide a good and in particular light-weight alternative to glazing made of mineral glass here. The toughness of polymethyl (meth)acrylate (PMMA) can be improved by adding impact modifiers. This generally leads to impairment of other properties, for example modulus of elasticity and surface hardness. Furthermore, the products, usually modified with butyl-acrylate-based impact modifiers, exhibit only small resistance to impact at low temperature. Plastics-laminate panels are an alternative which can increase impact resistance while retaining the surface hardness of polymethyl (meth)acrylate, and also retaining the modulus of elasticity. Application sectors in which these composites can be used are by way of example automotive glazing, and also other applications where the combination of high mechanical strength with the high modulus of elasticity of PMMA, and the high surface hardness, are required. These products can by way of example be transparent panels, protective covers for machines, add-on components for vehicles, for example wind deflectors, and roof modules.

EP 1577084 (KRD Coatings GmbH) describes a plastics laminate for vehicle glazing, where the inner side is composed of polycarbonate (PC) and the external side is composed of PMMA. The intermediate layer, intended to absorb the differences in thermal expansion of the plastics PC and PMMA, is composed of a thermoplastic polyurethane (TPU). No data concerning mechanical strength are provided. Polycarbonate moreover has the disadvantage of reduced weathering resistance, and composites of this type can therefore have a tendency towards discoloration when used for very long periods.

WO 02/47908 (VTEC Technologies) discloses a glazing element made of three layers of different plastics. One layer here is composed of PMMA, the intermediate layer is composed of a polyurethane (PU) or of polyvinyl butyral (PVB), and the other layer is composed of PC. The external sides of the glazing element have a scratch-resistant coating. No data are provided concerning the mechanical strength or other mechanical properties of the glazing element, except for data relating to scratch resistance. This type of system moreover also has the disadvantages resulting from the polycarbonate used.

WO 96/13137 (Decoma International) describes a glazing element for vehicles into which heating elements have been integrated, as is the case for example in tailgate windows of vehicles. The window here has a thin layer made of polycarbonate or polyester and a thick layer made of polycarbonate or polymethacrylate. However, combinations of materials of this type have only inadequate fracture resistance.

Patent Application DE 102006029613 describes a composite made of TPU and of two exterior PMMA layers. TPU used here can comprise not only polyester-based but also polyether-based polymers. The TPUs described can be linear or optionally branched. However, the TPUs used have a uniform structure in relation to their composition, and these are therefore either highly crystalline or completely amorphous. Crystalline TPUs are not sufficiently transparent for glazing, whereas amorphous TPUs are not sufficiently effective in providing fracture resistance.

### OBJECTS

In the light of the prior art discussed, it was therefore an object of the present invention to provide a novel type of highly transparent plastics laminates. This novel plastics-laminate panel is intended to have high transparency together with high fracture resistance.

Another object underlying the present invention was to avoid discoloration of the plastics-laminate panel that is to be developed, even when it is used for long periods under conditions of weathering, e.g. as automotive glazing.

Another object of the present invention was to develop a plastics-laminate panel of this type which is easy to produce, in general terms has good mechanical properties and is easy to use and to install.

Other objects underlying the invention can be implicitly apparent from the description, from the claims or from the examples, although they have not been explicitly listed here.

### ACHIEVEMENT OF OBJECTS

The plastics composite of the invention is composed of at least three layers of plastics, where the two exterior layers (1) and (2) are composed of transparent poly(meth)acrylate layers and the internal layer is composed of a thermoplastic polyurethane (TPU) (3).

According to the invention, the TPU is an uncrosslinked polyurethane which has hard segments and soft segments. In particular, the TPU has from 30 to 60% by weight, preferably from 30 to 45% by weight, of hard segments and from 40 to 70% by weight, preferably from 55 to 70% by weight, of soft segments.

The proportion of hard phase is determined by the following formula:

$$Proportion of hard phase = \{ {\sum }_{x = 1}^{k} [ ( {m}_{KVx} / {M}_{KVx} ) * {M}_{iso} + {m}_{KVx} ] \} * 100 wt \% / {m}_{tot}$$

where the symbols have the following meanings:

M_{KVx}: molar mass of the chain extender x in g/mol

m_{KVx}: mass of the chain extender x used in g

Mᵢₛₒ: molar mass of the isocyanate used in g/mol

mₜₒₜ: total mass of all starting materials in g

k: number of chain extenders.

Layer thicknesses of (1) and (2) can be in ranges from 0.1 to 6 mm, preferably from 1 to 4 mm, and those of (3) can be in the range from 0.05 to 5 mm, preferably from 0.5 to 1.5 mm. The layer thicknesses of (1) and (2) can be identical or different, and this means that a symmetrical structure of the layers is possible, as also is an asymmetrical structure of the layers. One exterior layer of the plastics laminate can be thicker, and the thickness ratio of the two exterior layers (1) and (2) made of transparent PMMA can be 1:100, preferably 1:50, particularly preferably 1:10.

Surprisingly, it was found that a combination of specific PMMA and TPU achieves excellent adhesion values in the composite, with a resultant improvement in mechanical properties.

One or both PMMA layers can moreover have IR-reflective pigments and/or UV absorbers and/or UV stabilizers. Suitable IR-reflective pigments are described by way of example in EP 1817375. Suitable UV absorbers or UV stabilizers are found in EP 1963415, and these can be used individually or in mixtures, including those of various UV stabilizers and, respectively, UV absorbers.

In order to achieve an in-depth effect similar to that of glass, one layer, preferably the inner layer in relation to the application, can have been coloured to some extent or entirely. Colouring used here can be transparent, for example shades of grey, to non-transparent, for example black.

At least one of the two PMMA layers optionally, but not necessarily, additionally comprises impact modifier. Surprisingly, it has been found that the plastics-laminate panels of the invention have good impact resistance even without impact modifier. Nevertheless, these can optionally be added. Impact modifiers that are suitable—also for transparent glazing—are well known to the person skilled in the art and can be found by way of example likewise in EP 1963415.

Appropriate plastics-laminate panels can be produced by in-mould coating of a first layer with the other two layers, or of a two-layer composite with the third layer. Other possible alternatives are coextrusion processes or lamination processes. It is preferable that the plastics-laminate panel of the invention is produced in a press. For this, the layers (1), (3) and (2) are mutually superposed, heated to a temperature of from 80 to 140° C. and, in a press, subjected to a force of from 10 to 100 kN over a period of from 20 to 60 s.

### DETAILED DESCRIPTION OF THE TPUs

As already stated, according to the invention the TPU is an uncrosslinked, thermoplastically processable, aliphatic polyurethane which has hard segments and soft segments. In particular, the TPU has from 30 to 60% by weight, preferably from 30 to 45% by weight, of hard segments. A feature of the TPUs used according to the invention is that the hard segments in the layer crystallize, while the soft segments are present in predominantly amorphous form in this layer. In order that the appearance of the glazing is not impaired, the hard segments are not permitted to be excessively large. Crystallites which would lead to refraction of light in the visible region and would therefore cause haze in the glazing are thus avoided within the matrix.

In another preferred embodiment the nature of the hard phase is such that only a small portion of the hard segment, more preferably the hard segment is practically non-crystalline. This has the advantage that the thermoplastic polyurethanes produced in this way have an improved transparency.

The soft segments of the TPU involve segments composed of predominantly aliphatic polyesters, of polyethers or of copolymers having ester groups and ether groups.

In another embodiment according to the invention the soft segment is composed of polycarbonates which are preferably based on alkanediols. Suitable polycarbonatediols have functional OH groups and are more preferably difunctional.

The soft segments are also termed polyols. The proportion of aromatic units in these segments is preferably smaller than 20% by weight, particularly preferably smaller than 10% by weight, and it is very particularly preferable that the soft segments have no aromatic units at all. The TPUs are produced by reacting the units for the soft segments in the form of diols with the other components required for the production process, for example in particular the diisocyanates described below. Aliphatic diisocyanates are preferred.

TPUs based on aliphatic polyesterdiols are particularly preferred, because the resultant TPUs have particularly good impact resistance and better UV resistance.

The number-average molar masses of the polyols preferably of the aliphatic polyesterdiols, are preferably from 0.500×10³g/mol to 8×10³ g/mol, preferably from 0.6×10³ g/mol to 4×10³ g/mol, in particular from 0.7×10³ g/mol to 2.6×10³ g/mol, and the average functionality thereof is preferably from 1.8 to 2.6, preferably from 1.9 to 2.2, in particular 2.

The term “functionality” in particular means the number of active hydrogen atoms, in particular those in hydroxyl groups.

In one preferred embodiment only one polyol is used, and in another preferred embodiment mixtures of polyols are used which in the mixture comply with the abovementioned requirements.

Diols used are preferably aliphatic polyesterdiols. Preference is given to polyesterdiols based on adipic acid and on mixtures of 1,2-ethanediol and 1,4-butanediol, to polyesteroles based on adipic acid and on mixtures of 1,4-butanediol and 1,6-hexanediol, to polyesteroles based on adipic acid and 3-methyl-1,5-pentanediol and/or polytetramethylene glycol (polytetrahydrofuran, PTHF), and/or polycaprolactone. Very particularly preferred polyesterdiol is polycaprolactone, the number-average molar masses of which are more preferably from 0.500×10³g/mol to 5×10³ g/mol, preferably from 0.8×10³ g/mol to 2.5×10³ g/mol, in particular from 0.8×10³ g/mol bis 2.2×10³ g/mol and very particularly preferably from 2×10³ g/mol.

The hard segments in turn involve segments which can be obtained by cocondensation of bifunctional isocyanates with relatively low-molecular-weight diols which have at most 10, preferably from 2 to 6, carbon atoms. The molar mass of these diols, which are also termed chain extenders, is preferably from 50 g/mol to 499 g/mol.

The bifunctional isocyanates can involve aromatic, cycloaliphatic or aliphatic diisocyanates. Particular preference is given to diisocyanates which are well known from polyurethane chemistry. An example of these is an MDI (diphenylmethane diisocyanate) as an example of aromatic diisocyanates or HDI (hexamethylene diisocyanate) or an H12MDI (dicyclohexylmethane diisocyanate) as examples of aliphatic diisocyanates.

Preferred isocyanates are tri-, tetra-, penta-, hexa-, hepta- and/or octamethylene diisocyanate, 2-methyl pentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophoron diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′- and/or 2,2′-diisocyanate, diphenylmethane 2,2′, 2,4′- and/or 4,4′-diisocyanate (MDI), naphthylene 1,5-diisocyanate (NDI), tolylene 2,4 and/or 2,6-diisocyanate (TDI), and/or dicyclohexylmethane 4,4′-diisocyanate (H12MDI).

Among these, further preference is given to the cycloaliphatic and/or aliphatic diisocyanates, and very particularly is given to dicyclohexylmethane 4,4′-diisocyanate (H12MDI), which is used with further preference as sole isocyanate.

TPUs based on aliphatic diisocyanates are preferred over those based on aromatic diisocyanates because they have higher UV resistance. Another variant can also use mixtures of various diisocyanates in the TPU.

The relatively small diisocyanates mentioned alone are too small to be capable of forming adequately long hard segments and thus forming desired crystallites, and a reaction of the hard segments is therefore carried out by using a relatively high concentration of diisocyanates and also adding diols, such as butanediol or hydroquinone, to give longer segments with various polyurethane groups. These diols are also termed chain extenders. These chain extenders used comprise well known aliphatic, aromatic and/or cycloaliphatic compounds. Preference is given to aliphatic chain extenders. The molar mass of the chain extenders is preferably from 50 g/mol to 499 g/mol. It is further preferable that the chain extenders have 2 functional groups. It is preferable that the chain extenders are diamines and/or alkanediols having from 2 to 10 carbon atoms in the alkylene group.

Preferred alkanediols are 1,2-ethanediol, 1,3-propanediol, 1,4-butanediol, 1,6-hexanediol and/or 1,4-di (β-hydroxyethyl)hydrochinone. Particular preference is given to 1,2-ethanediol, 1,4-butanediol and/or 1,6-hexanediol. Very particular preference is given to 1,4-butanediol. Preferred diamines are aliphatic diamines, in particular ethylenediamine or propylenediamine or a mixture comprising ethylenediamine and propylenediamine.

An entire chain of the TPUs used according to the invention has a plurality of soft segments and a plurality of hard segments. The length and the number of the individual segments can easily be adjusted by the person skilled in the art through suitable selection of the diols for the soft segments, the equivalents used of the individual constituents and the reaction conditions of the polycondensation that forms the polyurethane bonds.

A very particularly preferred thermoplastic polyurethane (TPU) is based on dicyclohexylmethane 4,4′-diisocyanate(H12MDI) and polycaprolactone polyol, preferably with the chain extender 1,4-butanediol. This TPU preferably has a weight-average molecular weight of from 40×10³ daltons to 0.3×10⁶ daltons, preferably from 50×10³ to 0.15×10⁶ daltons and more preferably has from 30 to 60% by weight of hard segments, preferably from 30 to 45%, and from 40 to 70% by weight of soft segments, preferably from 55 to 70% by weight. The percentage proportion of the soft segments in the thermoplastic polyurethane is the difference between 100% by weight and the % by weight of hard phase, where the percentages by weight in the hard phase are calculated in accordance with the formula above.

Conventional additives which can be found by way of example in Polyurethane Handbook, 2nd Edition, Gunter Oertel, Hanser Publisher, Munich, 1993 pp. 98-119 can be added to the thermoplastic polyurethanes.

Additives added preferably include UV stabilizers, hydrolysis stabilizers and/or antioxidents; these increase the time for which the thermoplastic polyurethane retains its transparency. Preferred hydrolysis stabilizers are carbodiimides, epoxides and cyanates. Carbodiimides are obtainable commercially with trademarks such as Elastostab™ or Stabaxol™.

Preferred antioxidents are sterically hindered phenols and other reducing substances. Preferred UV stabilizers are piperidines, benzophenones or benzotriazoles. Examples of particularly suitable benzotriazole are Tinuvin® 213, Tinuvin® 234, Tinuvin® 571, and also Tinuvin® 384 and Eversorb®82.

Quantities usually added of UV absorbers, based on the total mass of TPU, are from 0.01% to 5% by weight, preferably from 0.1% by weight to 2.0% by weight, in particular from 0.2% by weight to 0.5% by weight.

In one particularly preferred embodiment no UV stabilizers are added to the thermoplastic polyurethane, but in this case further preference is given to addition of hydrolysis stabilizers and/or antioxidents.

### DETAILED DESCRIPTION OF THE PMMA LAYERS

The exterior layers of the plastics-laminate panel of the invention are composed of PMMA. PMMA is generally obtained by free-radical polymerization of mixtures which comprise (meth)acrylates. The term (meth)acrylates includes methacrylates and acrylates, and also mixtures of the two. The PMMA here is composed predominantly of repeating units which are obtained through polymerization of methyl methacrylate (MMA). According to one preferred aspect of the present invention, the monomer mixtures used for the production of the PMMA comprise at least 60% by weight, preferably at least 80% by weight and particularly preferably at least 90% by weight, based on the weight of the monomers, of methyl methacrylate.

However, the PMMA used according to the invention can moreover also comprise other comonomers, in particular methacrylates or acrylates. In particular, copolymerization of even small amounts of acrylates can markedly increase the thermal stability of the claimed polymethyl methacrylates.

The PMMA products suitable for the production of glazing are well known to the person skilled in the art and can be found by way of example in DE 102006029613. The polymers can also be used individually or as a mixture. Moulding compositions which can be used by way of example and which comprise poly(meth)acrylates are obtainable commercially with trademark PLEXIGLAS® XT or PLEXIGLAS® 8N from Evonik Ind.

The plastics sheets of the invention can by way of example be produced from moulding compositions of the abovementioned polymers. Thermoplastic shaping processes are generally used here, for example extrusion or injection moulding. The plastics sheets can moreover be produced by cell-casting processes. In these, by way of example, suitable acrylic resin mixtures are charged to a mould and polymerized. Sheets produced in this way are obtainable commercially with trademark PLEXIGLAS® GS from Evonik Ind. It is also possible to use sheets obtained from continuous casting processes.

### ADDITIVES

The moulding compositions to be used for the production of the plastics sheets can moreover comprise conventional additives of any type, as also can the acrylic resins. Among these are inter alia antistatic agents, antioxidants, mould-release agents, flame retardants, lubricants, dyes, flow improvers, fillers, light stabilizers and organic phosphorus compounds, such as phosphites or phosphonates, pigments, weathering stabilizers and plasticizers. The amount of additives is to be adjusted appropriately for the respective application.

Sheets produced according to one of the abovementioned processes can be transparent or coloured sheets. By way of example, dyes or pigments can be used to colour the sheets. Accordingly, any desired plastics sheets can be combined with one another according to the process of the present invention. By way of example, PLEXIGLAS® XT sheets can be combined with PLEXIGLAS® GS sheets and/or PLEXIGLAS® GS sheets can be combined with PLEXIGLAS® SZ sheets and/or PLEXIGLAS® LSW sheets can be combined with PLEXIGLAS® XT sheets, and it is possible here to bond a colourless sheet to a coloured sheet or to bond two colourless sheets or two coloured sheets to one another.

### USE

It is preferable that the plastics-laminate panels of the invention are used as glazing in an automobile, in a rail vehicle, in an aircraft, in a greenhouse, in a hoarding or in a building.

### EXAMPLES

PLEXIGLAS® 6N is a PMMA moulding composition from Evonik Ind. This involves a copolymer of methyl methacrylate and methyl acrylate with molar mass about 120 000 g/mol. Detailed data can be found in the data sheet provided by Evonik Ind. for PLEXIGLAS® 6N or from materials data banks, e.g. CAMPUS.

ELASTOLLAN® L785A10 is an aliphatic polyester urethane from BASF Polyurethanes GmbH with a proportion of 38% of hard segment, Shore A hardness 85, tensile strain at break 520% and MVR (190° C./10 kg) 38 cm³/10 min. This aliphatic polyester urethane is based on polycaprolactone with number-average molar mass 2.0×10³ g/mol as polyol, 1,4-butanediol as chain extender and dicyclohexylmethane diisocyanate (H12MDI) with suitable antioxidants, hydrolysis stabilizer and UV stabilizers.

ELASTOLLAN® L1154D10 is an aliphatic-polyether-based TPU from BASF Polyurethanes GmbH with a proportion of 50% of hard segment, Shore D hardness 63, tensile strain at break 310% and MVR (200° C./21.6 kg) 19.6 cm³/10 min. This aliphatic polyether urethane is based on polytetrahydrofuran (PTHF) with number-average molar mass 1.0×10³ g/mol as polyol, 1,4-butanediol as chain extender and dicyclohexylmethane diisocyanate (H12MDI) with suitable antioxidants, hydrolysis stabilizer and UV stabilizers.

ELASTOLLAN® L1185A10 (3) is an aliphatic-polyether-based TPU from BASF Polyurethanes GmbH with a proportion of 38% of hard segment, Shore D hardness 42, tensile strain at break 380% and MVR (200° C./21.6 kg) 25.1 cm³/10 min. This aliphatic polyether urethane is based on polytetrahydrofuran (PTHF) with number-average molar mass 1.0×10³ g/mol as polyol, 1,4-butanediol as chain extender and dicyclohexylmethane diisocyanate (H12MDI) with suitable antioxidants, hydrolysis stabilizer and UV stabilizers.

### Example 1

A Dr Collin coextrusion plant, equipped with a coextrusion die of width 240 mm, a single-screw extruder (45 mm screw diameter and screw length 40D) and two co-extruders (screw diameter 20 mm, screw length 40 D) was used to extrude plastics composites of the invention, composed of three layers, where the two exterior layers (1) and (2) are composed of PLEXIGLAS® 6N and the internal layer is composed of ELASTOLLAN® L785A10 TPU (3). The thickness of each of the two exterior layers (1) and (2) made of PLEXIGLAS® 6N is 2 mm. The thickness of the internal layer made of ELASTOLLAN® L785A10 TPU (3) is 500 pm. Test specimens with width and length respectively 90 mm were cut out from the extruded sheets by means of a laser. Penetration tests to determine mechanical properties based on DIN EN ISO 6603-2 were carried out on these test specimens. The penetration tests were carried out in a Zwick/Roell Amsler HTM 5020 with a maximal penetration force of 50 N and a test velocity of 1 m/s at 23° C. In each case, 3 specimens were tested. The measured values stated are the average values from the 3 individual measurements. The expression “based on DIN EN ISO 6603-2” means in this context that the following sections of the test specification deviated from the standard: the standard gives the dimensions of the test specimen as diameter 60 mm and thickness 2 mm. The corresponding dimensions of the test specimens used for the measurements were D=89 mm and t=4 mm. The penetration tests carried out to determine mechanical properties gave a penetration energy of 11 500 Nmm for composites made of aliphatic-polyester-based ELASTOLLAN® L785A10 TPU in combination with PLEXIGLAS® 6N.

### Example 2

As described in Example 1, a Dr Collin coextrusion plant was used to extrude a plastics composite composed of three layers. The two exterior layers (1) and (2) here are composed of PLEXIGLAS® 6N and the internal layer is composed of ELASTOLLAN® L1154D10 TPU (3), an aliphatic-polyether-based TPU. The thickness of each of the two exterior layers (1) and (2) made of PLEXIGLAS® 6N is 2 mm, as in Ex. 1. The thickness of the internal layer made of ELASTOLLAN® L1154D10 TPU (3) is 500 μm. Test specimens with edge lengths of 90 mm were cut out from the extruded sheets, as in Ex. 1, by means of a laser. Penetration tests to determine mechanical properties based on DIN EN ISO 6603-2 were carried out on the test specimens.

In comparison with the composites used in Ex. 1, made of aliphatic-polyester-based ELASTOLLAN® L785A10 TPU in combination with PLEXIGLAS® 6N, the penetration energy of the composite using ELASTOLLAN® L1154D10 TPU (3) with PLEXIGLAS® 6N is 3500 Nmm.

### Example 3

As described in Example 1, a Dr Collin coextrusion plant was used to produce plastics-composite sheets composed of three layers, where the two exterior layers (1) and (2) are composed of PLEXIGLAS® 6N and the internal layer is composed of ELASTOLLAN® L1185A10 TPU (3), an aliphatic-polyether-based TPU.

Test specimens extracted from the sheets were used for penetration tests to determine mechanical properties, based on DIN EN ISO 6603-2.

The penetration energy of the composite made of ELASTOLLAN® L1185A10 TPU (3), an aliphatic-polyether-based TPU, in combination with PLEXIGLAS® 6N is 6000 Nmm.

### Example 4

An extruded PLEXIGLAS® XT sheet of thickness 2 mm is inserted into a press tool with a recess measuring 193 mm×120 mm in a heating-cooling press. A TPU foil extruded from ELASTOLLAN® L785A10, thickness 500 μm, is placed on the sheet and another extruded PLEXIGLAS® XT sheet of thickness 2 mm is then inserted. Once the tool has been closed, the moulding press is heated to 130° C. and subjected to pressure from a force of 70 kN over a period of 40 s.

Once the moulding press has been cooled, the resultant plastics laminate is demoulded and used to produce test specimens with edge lengths of in each case 90 mm. Penetration tests to determine mechanical properties based on DIN EN ISO 6603-2 were carried out on the test specimens.

The penetration tests carried out gave a penetration energy of 11 300 Nmm for the composite made of aliphatic-polyester-based ELASTOLLAN® L785A10 TPU in combination with PLEXIGLAS® XT.

TABLE 1
Comparison of properties of various extruded plastics composites composed
of PLEXIGLAS ® 6N and, respectively, XT and of various TPUs

| | | | | Penetration |
|---|---|---|---|---|
| | | | | energy |
| | PMMA | TPU | TPU | [Nmm] |
| Experiment 1 | PLEXIGLAS 6N | ELASTOLLAN L785A10 | aliphatic-polyester-based | 11 500 |
| Experiment 2 | PLEXIGLAS 6N | ELASTOLLAN L1154D10 | aliphatic-polyether-based | 3500 |
| Experiment 3 | PLEXIGLAS 6N | ELASTOLLAN L1185A10 | aliphatic-polyether-based | 6000 |
| Experiment 4 | PLEXIGLAS XT | ELASTOLLAN L785A10 | aliphatic-polyester-based | 11 400 |

1. A plastic laminate made of comprising:
at least two poly(meth)acrylate layers (1) and (2), and
a layer comprising a thermoplastic polyurethane (3) and located between the at least two poly(meth)acrylate layers (1) and (2),
wherein the thermoplastic polyurethane comprises from 30 to 60% by weight of hard segments and from 40 to 70% by weight of soft segments.

2. The plastic laminate of claim 1, wherein the thermoplastic polyurethane comprises from 30 to 45% by weight of hard segments and from 55 to 70% by weight of soft segments.

3. The plastic laminate pf claim 1, wherein the soft segments of the thermoplastic polyurethane comprise, in reacted form, an aliphatic polyesterdiol and diisocyanate.

4. The plastic laminate of claim 1, wherein the hard segments comprise, in reacted form, a diisocyanate and an alkyl diol that has at most 10 carbon atoms.

5. The plastic laminate of claim 3, wherein the diisocyanate comprises hexamethylene diisocyanate (HDI) or dicyclohexylmethane diisocyanate (H12MDI).

6. The plastic laminate of claim 1, wherein the poly(meth)acrylate layers (1) and (2) comprise, in reacted form, a monomer mixture comprising at least 90% by weight of MMA.

7. The plastic laminate of claim 1, wherein one or both poly(meth)acrylate layers comprise an IR-reflective pigment and/or a UV absorber and/or a UV stabilizer.

8. The plastic laminate of claim 1, wherein at least one of the two poly(meth)acrylate layers further comprises an impact modifier.

9. A process for producing the plastic laminate of claim 1, comprising:
mutually superposing the layers (1), (3) and (2),
heating the superposed layers to a temperature of from 80 to 140° C. and,
pressing the superposed layers at a force of from 10 to 100 kN over a period of from 20 to 60 s.

10. A glazing comprising the plastic laminate of claim 1.

11. The plastic laminate of claim 4, wherein the diisocyanate comprises hexamethylene diisocyanate (HDI) or dicyclohexylmethane diisocyanate (H12MDI).
